(19) United States
(12) Patent Application Publication
(10) Pub. No.: US 2003/0040902 A1
(43) Pub. Date: Feb. 27, 2003

(54) System and method of learning a foreign language

(76) Inventors: Sayling Wen, Taipei (TW); Zechary Chang, Taipei (TW); Pinky Ma, Beijing (CN); Dragon Huang, Beijing (CN)

Correspondence Address: BIRCH STEWART KOLASCH & BIRCH, PO BOX 747, FALLS CHURCH, VA, 22040-0747, US

(21) Appl. No.: 09/935,747

(22) Filed: Aug. 24, 2001

(51) Int. Cl. G06F 17/28

(52) U.S. Cl. 704/4

(57) ABSTRACT

A system of learning a foreign language, including a document receiving module, a document partitioning module and a sentence dividing module. The document receiving module receives a language document entered by a learner. The document partitioning module partitions the language document into at least one independent sentence. The sentence dividing module divides the independent sentence into a plurality of elements. After obtaining the elements, a sentence-making language learning module changes the order of the elements to obtain a shuffled sentence for the learner, and accepts the learner's input. The sentence-making language learning module then compares the independent sentence with the learner's input and outputs a result to the learner.

### BACKGROUND OF THE INVENTION

1. Field of Invention

The invention relates to a system and a method of learning a foreign language and, in particular, to a system and a method, which converts a document entered by a learner into at least one problem for the user to learn a foreign language by composing sentences.

2. Related Art

Normally, language learners learn how to make a sentence by memorizing or analyzing the structure of some finite amount of typical sentences. Such a method is good for getting familiar with the sentence structures without emphasizing upon the applications and acquaintance of elementary components such as tenses, prepositions, and articles. Therefore, this kind of learning cannot provide effective help for learners to think in the foreign language. Thus, the learners cannot form a proper sentence in real applications.

Along with the maturity of computer technologies, many companies have come up with computer aided foreign language learning materials in recent years. However, most of them simply provide a huge amount of contents or a big test problem database for learners to practice over and over again. They do not fully utilize the characters of computers such as the possible high interactions between a computer and a user and the convenience of using computers. Therefore, such computer-aided tool is not able to provide integrated practices by providing test problems with increasing difficulty.

In addition, the foreign language learning materials using computers as aided tools often have a fixed number of sentences. Even if some of them can use hardware or software to expand its sentence database, it is still impossible to satisfy individual needs. For example, if the textbook is something related to literature and the learner is a student major in politics, then he or she may not be able to learn sentences related to politics from the material. Therefore, due to the limitation of finite learning materials, traditional computer-aided tools for learning a foreign language makes the learner unable to input and update the contents according to his or her own will. Such computer-aided tool then limits the scope the learner can learn about the foreign language, thus discouraging the learner from learning the language.

Consequently, how to utilize the mature computer technologies for more efficient foreign language teaching by making problems with increasing difficulty and the contents needed by various kinds of learners is an urgent and important issue.

### SUMMARY OF THE INVENTION

Pursuant to the above-mentioned problems, the invention provides a system and a method of learning a foreign language, which satisfy the individual need of a learner.

It is another object of the invention to provide a system and a method of learning a foreign language, which can help a learner to learn a foreign language by making sentences with increasing difficulty.

To achieve the above objects, the disclosed system of learning a foreign language includes a document receiving module, a document partitioning module and a sentence dividing module. The document receiving module accepts a language document entered by a learner. The document partitioning module partitions the language document into at least one independent sentence. The sentence dividing module divides the independent sentence into a plurality of elements. After obtaining the elements, a sentence-making language learning module changes the order of the elements to obtain a shuffled sentence for the learner, and accepts the learner's input. The sentence-making language learning module then compares the independent sentence with the learner's input and outputs a result to the learner.

According to an embodiment of the invention, the disclosed system further includes a tagging module, which adds a tag to each of the elements according to their attributes. Thereafter, the sentence-making language learning module can perform substitutions or shuffles to the elements according to the tags, so as to provide problems with increasing difficulty.

The invention also discloses a method of learning a foreign language, includes a document receiving procedure, a document partitioning procedure, and a sentence dividing procedure. The document receiving procedure accepts a language document entered by a learner. The document partitioning procedure partitions the language document into at least one independent sentence. The sentence dividing procedure divides the independent sentence into a plurality of elements. After obtaining the elements, a sentence-making language learning module then changes the order of the elements to form a shuffled sentence and outputs it to the learner. After accepting the learner's input, the sentence-making language learning module compares the independent sentence with the learner's input and outputs the result to the learner.

The disclosed system and method can fully utilize the computer and/or network technologies for language learners to input the desired contents to learn. Therefore, they can effectively increase the learners' foreign language abilities.

The disclosed system and method can fully utilize the computer and/or network technologies to provide problems with increasing difficulty so as to gradually enhance the learners' foreign language abilities.

### BRIEF DESCRIPTION OF THE DRAWINGS

The invention will become more fully understood from the detailed description given hereinbelow illustration only, and thus are not limitative of the invention, and wherein:

FIG. 1 is a schematic view showing how the foreign language system interacts with a learner and a sentence-making language learning module according to a preferred embodiment of the invention;

FIG. 2 is a schematic view showing the language document received by the document receiving module of the disclosed system;

FIG. 3 is a schematic view showing the language document being partitioned into a plurality of independent sentences by the document partitioning module of the disclosed system;

FIG. 4 is a schematic view showing an independent sentence being divided into a plurality of elements by the sentence dividing module of the disclosed system;

FIG. 5 is a schematic view showing a plurality of elements and their tags;

FIG. 6 is a schematic view showing the result of combining the disclosed foreign language learning system and the sentence-making language learning module; and

FIG. 7 is a flowchart showing the disclosed method.

### DETAILED DESCRIPTION OF THE INVENTION

The invention will be apparent from the following detailed description, which proceeds with reference to the accompanying drawings, wherein the same references relate to the same elements.

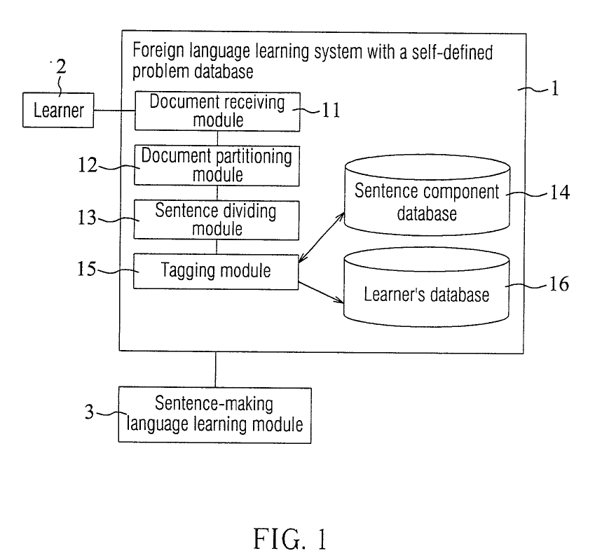

With reference to FIG. 1, the system 1 of learning a foreign language according to a preferred embodiment couples to a sentence-making learning module 3, and includes a document receiving module 11, a document partitioning module 12, a sentence dividing module 13, a sentence component database 14, a tagging module 15, and a learner's database 16.

In the preferred embodiment, the system 1 is implemented in a computer device, which includes at least a CPU (Central Processing Unit), a computer readable storage device and other peripheral devices for accomplishing desired functions, such as the input devices (keyboard and mouse), that communicate or record information in terms of physical electrical signals. The document receiving module 11, the document partitioning module 12, the sentence dividing module 13, and the tagging module 15 are program modules stored in the computer readable storage device. Through the operations of the CPU, the functions can be achieved through hardware operations and electrical signal transmissions.

In the preferred embodiment, the sentence component database 14 and the learner's database 16 can be any computer readable database. For example, the sentence component database 14 and the learner's database 16 can use the traditional SQL or Access database. Of course, any person skilled in the art can design a data structure and file format as the sentence component database 14 and the learner's database 16 according to the practical needs.

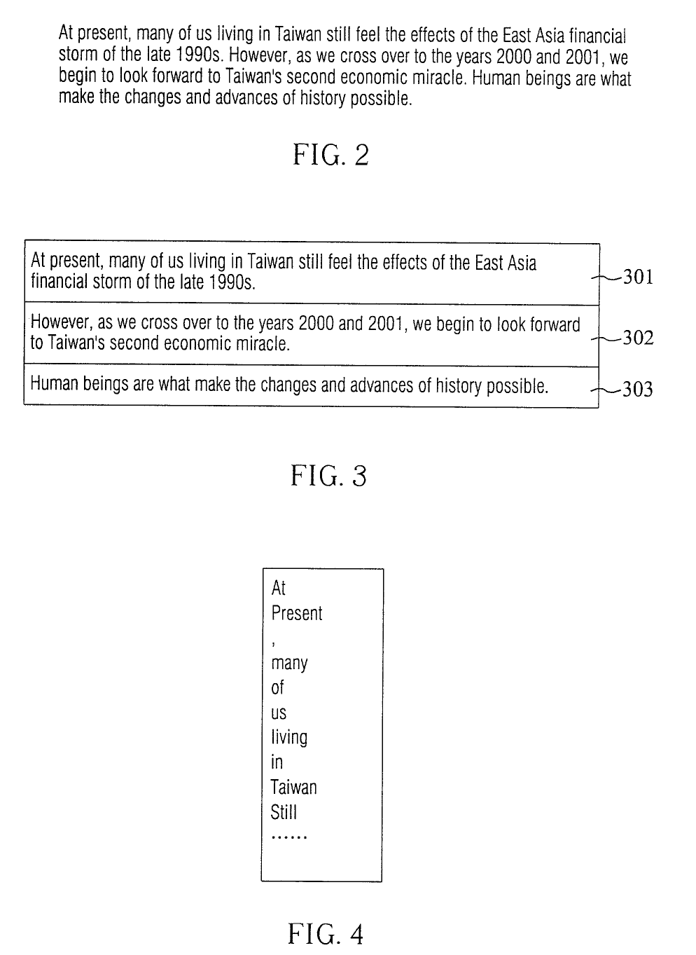

The document receiving module 11 receives the language document entered by a learner 2 as shown in FIG. 2. For example, the learner 2 can extract an article from a website, or copy a plurality of sentences from a text file, and save it as a computer readable file as a language document. Furthermore, the learner 2 can use a scanner and the corresponding software to scan an article in a book and converts it into a computer readable text file as a language document.

The document partitioning module 12 partitions the language document into independent sentences 301 through 303 as shown in FIG. 3. The document partitioning module 12 can use such symbols as periods, question marks, and acclamation marks to partition the language document 3 into three independent sentences shown in FIG. 3. The sentence dividing module 13 further divides each independent sentence into a plurality of elements. For example, the independent sentence 301 is divided into the elements shown in FIG. 4 and the elements include words, punctuations, and phrases.

The sentence component database 14 stores several sentence components, including phrases and words. The words stored in the sentence component database 14 include words with at least one form derivative, words with at least one category derivative, and words with at least one interfering unit.

The words with at least one form derivative refer to words with several different forms. For example, the word “have” has a past tense “had” and a progressive tense “having”. Another example is that the word “candy” has the singular form “candy” and the plural form “candies”. Also, the word “I” and the nominative case “I” and the objective case “me”.

The words with at least one category derivative refer to words that are easy to be mixed with others. For example, the preposition “in” is often mixed with “on”, “at”, or “of” in uses.

The words with at least one interfering unit refer to words that are often incorrectly used. For example, “the”, “a” and “an” are words that learners often misuse.

The tagging module 15 adds a tag onto an element according to the content of the sentence component database 14. In other words, the tagging module 15 adds a tag onto each element according to the attribute of the element. For example, the first element “At” in FIG. 3 is categorized as a word with at least one category derivative in the sentence component database 14. Therefore, the tagging module 15 puts a category tag on the word “At”. Moreover, the element “living” is categorized as a word with at least one form derivative in the sentence component database 14.. Thus, the tagging module 15 puts a form tag on the word “living”.

If the element in the sentence component database 14 is categorized as a word with at least one interfering unit, the tagging module 15 adds an interference tag to the element. If the element is categorized as a phrase in the sentence component database 14, the tagging module 15 adds a phase tag to the element.

When a sentence component complying with the element cannot be found in the sentence component database 14, the element is considered as an ordinary word. Foe example, the word “Taiwan” in the independent sentence 301 is considered as an ordinary word by the tagging module 15 without being attached with any tag.

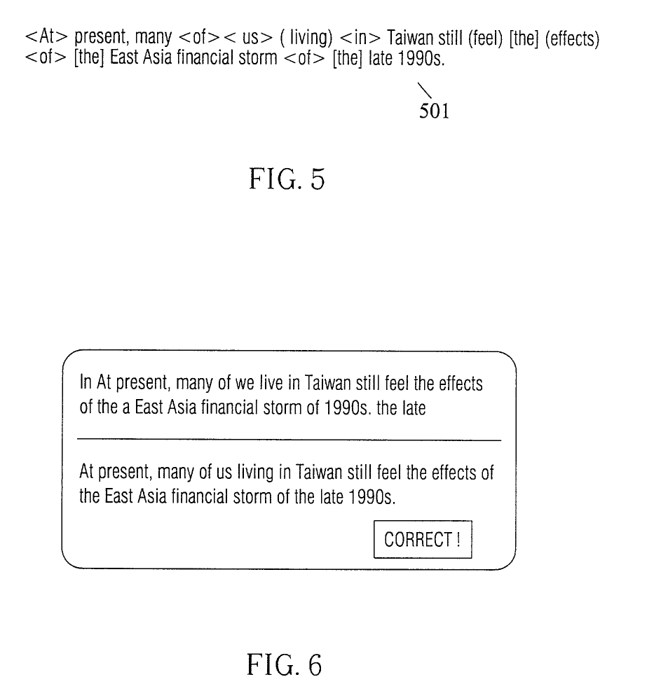

After the tagging module 15 finishes tagging all elements in the independent sentence, the independent sentence and the corresponding tagged elements are stored in the learner's database 16. As shown in FIG. 5, the independent sentence being processed by the tagging module 15 has ( ), <>, and [ ] to represent form tags, category tags, and interference tags, respectively.

The disclosed system 1 couples to a sentence-making language learning module 3. The sentence-making language learning module 3 can be a program module stored in the above-mentioned computer device or in another computer device. If the sentence-making language learning module 3 and the system 1 are not installed in the same computer device, then they can be connected via an LAN (Local Area Network) or the Internet to transmit signals back and forth.

The sentence-making language learning module 3 can change the order of the divided elements to obtain a shuffled sentence and output it to the learner 2. After receiving the input from the learner 2, the sentence-making language learning module 3 compares the independent sentence with the input from the learner 2 and outputs the result to the learner 2.

For example, the sentence-making language learning module 3 retrieves the independent sentence 301 from the sentence component database 14 and the tagged elements 501 to perform recombination. The sentence-making language learning module 3 then make substitutions for the divided elements according to their attributes. The substitution can be changing an element into its other form. The word “had” is attributed to have many different forms, and it can be changed from the past tense to its present tense “have”. In addition, the sentence-making language learning module 3 further performs mixture processing according to the attributes of the divided elements. The mixture processing can be adding other words or punctuations in the shuffled sentence. For example, the element “the” is often misused (learners often use the definite article “the” when it really should be an indefinite article “a”), so “a” is added to the shuffled sentence.

As shown in FIG. 6, the sentence-making language learning module 3 outputs the tagged element 501 to the learner 2 in a window. The learner 2 can click the word in the window using a mouse or enters a sentence directly through a keyboard. Finally, the sentence-making language learning module 3 compares the independent sentence 301 and the learner's input and outputs the result to the learner 2.

The disclosed foreign language learning system I and the sentence-making language learning module 3 can be integrated into a network server. Alternatively, the foreign language learning system can be independently stored in a computer readable storage medium. It should be emphasized that each of the databases and modules can be stored in any computer readable storage medium, such as a hard disk drive, memory, a floppy disk or a CD-ROM, so that the network server can implement the desired functions. Furthermore, the foreign language learning system can be made into a chip module or an external jacket to be used in an electronic dictionary or PDA (Personal Digital Assistant) with the sentence-making language learning module.

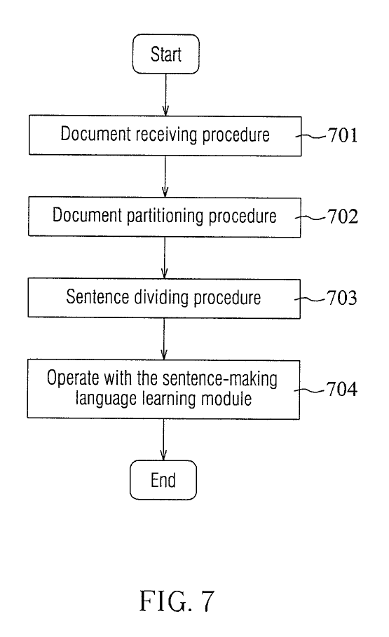

With reference to FIG. 7, the method 6 of learning a foreign language first performs a document receiving procedure 701 to receive a language document transmitted from a learner 2 as shown in FIG. 2. As described before, the learner 2 can extract an article from a computer readable document as the language document.

In a document partitioning procedure 702, the language document is partitioned by such symbols as periods, question marks, and acclamation marks into at least one independent sentence. In the sentence dividing procedure 703, each independent sentence is divided into a plurality of elements. The sentence dividing procedure 703 uses such symbols as space and commas to divide the independent sentence into a plurality of elements as shown in FIG. 4. The divided elements include words, punctuations, and phrases. According to the attributes of the elements, a tag is added to each of the elements. As described before, the attributes include having different forms, being easy to be mixed with others, being easy to be misused and phrases.

In step 704, the divided elements are used in an electronic device with a sentence-making language learning module so that the sentence-making language learning module changes the order of the divided elements. In addition, the sentence-making language learning module also performs substitutions and mixings for the divided elements. The substitution changes, for example, from the past tense to the present tense. The mixing adds extra words according to the attributes of the divided elements. For example, the divided elements include the word “the”, then the word “a” is added. Finally, a shuffled sentence is obtained and output to the learner 2. After accepting the learner's input, the sentence-making language learning module compares it with the independent sentence and outputs the result to the learner 2.

The disclosed system and method fully utilizes the high interactivity between computers and learners and the convenience of computer uses. Therefore, the invention is more efficient in language learning than traditional methods.

The disclosed system and method can fully utilize the computer or network technologies to implements the feature that the learner can input the learning contents by himself. Thus, the invention can effectively enhance the foreign language ability of the learner.

The disclosed system and method uses different criteria, combinations, and form variations to change the learning modes. Therefore, the invention can gradually increase the difficulty to enhance the learning effects.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system of learning a foreign language coupled to a sentence-making language learning module, comprising:
a document receiving module for receiving a language document transmitted from a learner;
a document partitioning module for partitioning the language document into at least one independent sentence; and
a sentence dividing module for dividing the independent sentence into a plurality of elements;
wherein the sentence-making language learning module changes the order of the divided elements to obtain a shuffled sentence and output the shuffled sentence to the learner, and after receiving an input from the learner the sentence-making language learning module compares the learner's input with the independent and outputs the comparison result to the learner.

2. The system of claim I further comprising:
a tagging module for adding at least one tag to at least one of the elements according to their attributes.

3. The system of claim 2 further comprising:
a learner's database, which stores the divided elements and the tags.

4. The system of claim 2, wherein
the sentence-making language learning module further performs substitutions on the divided elements according to the tags.

5. The system of claim 2, wherein
the sentence-making language learning module further performs mixings on the divided elements according to the tags.

6. The system of claim 2 further comprising:
a sentence component database, which stores a plurality of sentence components and the tagging module adds at least one tag to each of the elements according to the content of the sentence component database.

7. The system of claim 6, wherein
the sentence components stored in the sentence component database include phrases; and
the tag is a phrase tag.

8. The system of claim 6, wherein
the sentence components stored in the sentence component database include words with at least one form derivative; and
the tag is a form tag.

9. The system of claim 6, wherein
the sentence components stored in the sentence component database include words with at least one category derivative; and
the tag is a category tag.

10. The system of claim 6, wherein
the sentence components stored in the sentence component database include words with at least one interfering unit; and
the tag is an interference tag.

11. A method of learning a foreign language used in an electronic device with a sentence-making language learning module, comprising the procedures of:
receiving a language document transmitted from a learner;
partitioning the language document into at least one independent sentence; and
dividing the independent sentence into a plurality of elements;
wherein the sentence-making language learning module changes the order of the divided elements to obtain a shuffled sentence and output the shuffled sentence to the learner, and after receiving an input from the learner the sentence-making language learning module compares the learner's input with the independent and outputs the comparison result to the learner.

12. The method of claim 11 further comprising:
adding at least one tag to at least one of the elements according to their attributes.

13. The method of claim 12 further comprising:
storing the divided elements and the tag to a learner's database.

14. The method of claim 12, wherein
the sentence-making language learning module further performs substitutions on the divided elements according to the tags.

15. The method of claim 12, wherein
the sentence-making language learning module further performs mixings on the divided elements according to the tags.

16. The method of claim 12, wherein
when adding the tag to the elements, a sentence component database storing a plurality of sentence components is referenced.

17. The method of claim 16, wherein
the sentence components stored in the sentence component database include phrases; and
the tag is a phrase tag.

18. The method of claim 16, wherein
the sentence components stored in the sentence component database include words with at least one form derivative; and
the tag is a form tag.

19. The method of claim 16, wherein
the sentence components stored in the sentence component database include words with at least one category derivative; and
the tag is a category tag.

20. The method of claim 16, wherein
the sentence components stored in the sentence component database include words with at least one interfering unit; and
the tag is an interference tag.

21. A storage medium storing program codes used to direct a electronic device with a sentence-making language learning module to execute the procedures of:
receiving a language document transmitted from a learner;
partitioning the language document into at least one independent sentence; and
dividing the independent sentence into a plurality of elements;
wherein the sentence-making language learning module changes the order of the divided elements to obtain a shuffled sentence and output the shuffled sentence to the learner, and after receiving an input from the learner the sentence-making language learning module compares the learner's input with the independent and outputs the comparison result to the learner.

22. The storage medium of claim 21, wherein the program codes further direct the electronic device to execute to procedure of:
add at least one tag to at least one of the elements according to their attributes.

23. The storage medium of claim 22, wherein the program codes further direct the electronic device to execute to procedure of:
storing the divided elements and the tag to a learner's database.

24. The storage medium of claim 22, wherein
the sentence-making language learning module further performs substitutions on the divided elements according to the tags.

25. The storage medium of claim 22, wherein
the sentence-making language learning module further performs mixings on the divided elements according to the tags.

26. The storage medium of claim 22, wherein
when adding the tag to the elements, a sentence component database storing a plurality of sentence components is referenced.

27. The storage medium of claim 26, wherein
the sentence components stored in the sentence component database include phrases; and
the tag is a phrase tag.

28. The storage medium of claim 26, wherein
the sentence components stored in the sentence component database include words with at least one form derivative; and
the tag is a form tag.

29. The storage medium of claim 26, wherein
the sentence components stored in the sentence component database include words with at least one category derivative; and
the tag is a category tag.

30. The storage medium of claim 26, wherein
the sentence components stored in the sentence component database include words with at least one interfering unit; and
the tag is an interference tag.
